(19) United States
(12) Patent Application Publication
(10) Pub. No.: US 2012/0270087 A1
(43) Pub. Date: Oct. 25, 2012

(54) BATTERY HOLDING UNIT

(75) Inventors: Tim Schaefer, Niedersachswerfen (DE); Andreas Gutsch, Luedinghausen (DE)

(73) Assignee: Li-Tec Battery GmbH, Kamenz (DE)

(21) Appl. No.: 13/499,493

(22) PCT Filed: Sep. 22, 2010
(86) PCT No.: PCT/EP10/05804

§ 371 Date: Jul. 9, 2012

(30) Foreign Application Priority Data
Oct. 2, 2009 (DE) 10 2009 048 147.8

(51) Int. Cl. H01M 2/10; H01M 10/46; H01M 2/20; H02J 7/00

(52) U.S. Cl. 429/100; 320/107; 29/825

(57) ABSTRACT

A battery holding unit (2) for accepting at least one electrochemical cell (3) comprises a support surface (4) for supporting an electrochemical cell (3) and a contacting unit (6) that has a contact surface (8). The contact surface can be made to rest against a current collector (9) of the electrochemical cell (3), and the contacting unit includes at least one contacting rail (7) on which the contact surface (8) is arranged.

The invention concerns a battery holding unit for the accommodation of at least one electrochemical cell.

Such battery holding units in particular find application in stationary battery stations. Regenerative energy sources such as for example wind energy or solar energy have the disadvantage of a fluctuating power output. In appropriate weather conditions wind power plants or solar power plants can output a high level of power, but in the event of a pertinent alteration in the state of the weather the power output can reduce to a very low level within a short space of time. Such fluctuations make it necessary to store the energy that is converted during favourable weather conditions. Storage of this kind can be undertaken in battery stations in which a multiplicity of electrochemical cells is provided. If the wind power plants or the solar power plants are providing only a small amount of power the battery stations can compensate for the reduced power output.

Battery holding units of this kind can, however, also be used in battery charging stations and forming plants.

U.S. Pat. No. 4,994,940 shows a modular cabinet with a multiplicity of battery modules. Individual cabinet modules can be pulled out by a user to provide access to the battery modules. Current collectors of the batteries are facing towards the cabinet module opening and contact is made with them by means of cables or plug-in connectors.

US 2001/031392 A1 shows a mounting frame for battery modules, which has a number of openings for introduction of the battery modules. A spring-loaded current collector holding fixture can make snap-in contact with a cylindrical current collector.

WO 2003/065483 A2 shows a battery accommodation frame for the accommodation of a plurality of batteries that are stacked one above another. The batteries are connected with a side plate. The batteries have ribs on vertical side faces, which can be introduced into grooves on the side plates. The side plates comprise vertical edges, onto which electrical connecting elements can be fitted. The connecting elements extend in each case from an upper section of one of the batteries to a lower section of the battery that is arranged above it, so that individual batteries can be electrically connected with one another.

DE 44 11 842 A1 shows a battery charging station, which comprises a vertical conveyor with gondola-type baskets. Vehicle batteries can be accommodated in the baskets and charged. The baskets' current collectors are in sliding contact with power rails and are connected by means of cables to the batteries.

It is the object of the present invention to provide an improved battery holding unit for the accommodation of at least one electrochemical cell.

This object is achieved by means of a battery holding unit for the accommodation of at least one electrochemical cell, having a support surface for the purpose of depositing an electrochemical cell, and a contacting unit with a contact surface, wherein the contact surface can be brought into contact with a current collector of the electrochemical cell, and wherein the contacting unit has at least one contacting rail, on which the contact surface is arranged.

The contact surface can preferably be brought into contact directly with a current collector; alternatively, the contact surface can also be brought into contact with a current collector of the electrochemical cell indirectly.

In the context of the invention an electrochemical cell is to be understood as a device that serves for both the storage of chemical energy and the output of electrical energy. For this purpose the inventive electrochemical cell can be provided with an electrode stack or an electrode coil, which by means of a casing relative to the environment is to a large extent impervious to gases and liquids. The electrochemical cell can also be configured so as to accommodate electrical energy when it is being charged. It is then also called a secondary cell, or an accumulator.

Here a current collector is taken to mean an element that is manufactured from a current-conducting material. It serves the purpose of conducting current between two points that are geometrically separated from one another. In the present case a current collector can be connected with an electrode stack. In particular the current collector is thereby connected with all the electrodes, of an electrode stack of the same kind, i.e. with either the cathodes or the anodes. It is obvious that a current collector cannot simultaneously be connected with the cathodes and anodes of an electrode stack, since this would lead to a short-circuit. However, a current collector can be connected with different electrodes of different electrode stacks, for example, in the case of a series connection of two electrode stacks. At least one current collector preferably extends out of a casing of one electrochemical cell, and can thereby serve the purpose of connecting the battery cells to an external environment. The current collector can be integrally designed with one or a plurality of electrodes, or in principle can be designed in multiple pieces. A differentiation can be seen between current collector and electrode in that in particular the current collector is not coated with an active electrode material.

Here the contacting unit serves the purpose of making electrical contact between at least some parts of the battery holding unit, and at least some parts of the electrochemical cell to be accommodated. The contact surface, which is a component of the contacting unit, thereby consists of a current-conducting material, in particular a metallic material, and is provided for the purpose of making direct contact with another component, in particular the current conductor. However, a further component can also be arranged between the current conductor and the contact surface, such that the electrical contact between the contact surface and the current conductor can be made indirectly. In addition to the contact surface the contacting unit can have further components, which need not necessarily possess current-conducting properties.

Here a contacting rail is preferably to be understood as a component that has a cross-section that remains essentially constant over a certain axial extent. In a primary extent direction, namely in the present case a longitudinal axis, which preferably corresponds to a direction of introduction, the contacting rail in particular has an extent that is many times greater than that in other directions. The contacting rail can preferably be manufactured from an extruded profile section. An extruded profile section can be manufactured by pressing a blank through a die. The outer shape in the profile extrusion direction is thereby determined by the die, such that the cross-section remains essentially constant. The contact surface can be designed integrally with the contacting rail; in this case the contacting rail is manufactured from a current-conducting material. Alternatively, the contact surface can also be a separate component, which is arranged on the contacting rail. Here the contact surface can be connected with the contacting rail in the form of a material bond, or in a force fit manner. Here the contacting rail preferably has an essentially linear profile. The linear profile thereby preferably corresponds essentially to the longitudinal axis of the contacting rail.

The support surface can be provided and/or designed so as to hold or carry a component of the weight of the electrochemical cell. The support surface can be arranged on a contacting rail.

The inventive battery holding unit has the advantage that fitting the electrochemical cells and making contact with them can take place in a few steps of the method. With the positioning the electric chemical cells in their defined rest locations the correct contacts with and between them can already be made. The battery holding unit can thereby enable contact to be simply made with the electrochemical cells at different locations. Furthermore, different formats of electrochemical cells can be used in such battery holding units.

In a preferred configuration of the invention spring means can be provided, which impose a force on the contact surface. This imposition of a force can take place indirectly and/or directly. In an indirect application of force the spring means can preferably firstly impose a force on the contacting rail, by means of which a force is in turn imposed on the contact surface. However, the spring means can also be arranged between the contacting rail and the contact surface, such that the spring means impose a force on the contact surface relative to the contacting rail. Application of force can in principle take place in the direction towards the support surface, i.e., in particular, such that the application of force can take place in a direction at right-angles to a plane of the support surface. This is, in particular, of advantage if the contact between contact surface and current collector takes place along surfaces that are aligned essentially parallel to the support surface. Alternatively, the application of force can also take place in a direction that is aligned parallel to the plane of the support surface. This is in particular, of advantage if the contact surfaces and the current collectors are in contact with one another on surfaces that are aligned at right-angles to the plane of the support surface.

In particular, if the spring means impose a force on the contact surface in a direction running essentially transverse to the support surface, the electrochemical cell can be fixed in the battery holding unit by force fit such that further options for securement can be dispensed with. To this end the spring means can be dimensioned such that the electrochemical cells are held in their defined locations such that no inadvertent displacement is possible. In an intended manual or automated release of the electrochemical cell from its defined location, an actuation force can overcome the retention force determined by static friction. A current collector can preferably be seated on a support surface.

The contacting rail preferably has a greater extent along a longitudinal axis of the contacting rail than an electrochemical cell that is to be inserted. Here the contacting rail is preferably several times larger along the longitudinal axis of the contacting rail than an electrochemical cell that is to be inserted in this direction. By this means a plurality of electrochemical cells can be arranged one behind another along the contacting rail. Thus a plurality of electrochemical cells can preferably make contact with one contacting rail.

The contacting rail is preferably arranged spaced apart from the support surface. Thereby an holding space can preferably ensue between the contacting rail and the support surface, in which the electrochemical cell can be accommodated. The electrochemical cell can be accommodated between the contacting unit and the support surface; in particular, it can be accommodated in a force fit. The contacting rail can be fitted on a support surface of an adjacent battery holding unit. The contacting rail can extend from a support surface of an adjacent battery holding unit in the direction towards the support surface. A separate contacting rail can be designed in the support surface.

In principle a plurality of contacting rails can be provided, on each of which a contact surface is arranged. However a plurality of contacting rails can also be provided, on which one contact surface is arranged. Alternatively or in combination individual contacting rails can have a plurality of separate contact surfaces for this purpose. For all the options cited it is necessary that different contact surfaces can be aligned parallel to one another.

In one preferred configuration of the invention a contacting rail forms the support surface. Here at least two separate contacting rails are provided, between which the electrochemical cell can preferably be arranged. Two current conductors of the electrochemical cell can thereby make contact with contact surfaces of the two contacting rails. One of the contacting rails can be arranged vertically underneath, and can thereby preferably form the support surface, which essentially can also accommodate the weight of the electrochemical cell. The other contacting rail can be arranged above, and in addition to the contact functions can also effect lateral guidance of the electrochemical cell.

The support surface is preferably arranged essentially in a plane. The contacting rail is thereby preferably aligned essentially parallel to this plane. The plane can be horizontally aligned so that the weight of the electrochemical cell is completely supported by the support surface. The support surface can thereby take the form of a plate, over which the electrochemical cell can be moved. The support surface can thereby be held in a fixed position within the battery holding unit. Alternatively the support surface can also be held such that it can be moved relative to other components of the battery holding unit.

At least one contact surface preferably has means for the lateral guidance of the electrochemical cell, in particular for the lateral guidance of current conductors of the electrochemical cell. Such means can be formed by sidewalls. The sidewalls can extend essentially parallel to a longitudinal axis of the guide rail. Here the term “lateral guidance” can be understood to be a guidance of the type that can prevent any escape of the electrochemical cell, or parts thereof, transverse to the longitudinal axis of the contacting rail. At least one of the contacting rails can have a U-shaped holding space for purposes of accommodating a current conductor and/or other parts of the electrochemical cell.

A contacting rail preferably has a plurality of contact surface sections, wherein individual contact surface sections can be insulated from one another. These contact surface sections can be aligned along a common longitudinal axis, thus, in particular can be aligned one behind another. The contact surface sections can be formed from a common contact surface, wherein insulating interrupts of the contact surface can preferably be provided between individual contact surface sections. By this means a segmented design of the contact surfaces can ensue in overall terms. By this means contact surface sections can be designed along a longitudinal axis with differing electrical polarities. These differing polarities can thereby be used for different circuit connections for the electrochemical cells. The circuit connections can be altered during operation of the unit, while the mechanical arrangement of the electrochemical cells remains the same.

The support surface is preferably held such that it can be moved within the battery holding unit. The support surface can in particular be held such that it can be moved relative to a longitudinal axis of the contacting rail and/or to a direction of insertion of the electrochemical cells. The support surface can preferably be moved over a length that essentially corresponds to more than 50%, in particular, more than 75%, in particular, more than 90% of the length of the contacting rail. The support surface can thereby preferably be pulled out like a drawer from a housing of the battery holding unit. This has the advantage that electrochemical cells that are to be accommodated can firstly be placed in position on the support surface, and then in the same step of the method can be moved along the contacting rail.

The battery holding unit preferably has manoeuvring means. Here the term manoeuvring means is to be understood to mean, in particular, such means that enable or at least aid the movement of electrochemical cells from one contacting rail to another contacting rail, or from one contacting rail section to another contacting rail section, in particular, if the contacting rails or the contacting rail sections are arranged at an angle to one another and/or laterally displaced relative to one another. Such manoeuvring means can preferably comprise a turntable. The turntable can furthermore be arranged centrally relative to a number of contacting rail sections arranged in a star shape relative to one another. The turntable can thereby serve to provide the revolver-type transposition of electrochemical cells onto individual contacting rail sections arranged in a star shape relative to one another. The turntable is preferably of circular shape and held in particular such that it can rotate relative to a baseplate of the battery holding unit. The turntable preferably has a contacting rail section, which further preferably runs through a central point of the turntable. In order to enable an arrangement of electrochemical cells that saves as much space as possible, the star-shaped arrangement of the contacting rail sections arranged in a star shape relative to one another can be limited to just a region in the immediate vicinity of the turntable. Further contacting rail sections that are at a distance from the turntable need not necessarily be aligned in a star shape relative to one another. On a cover plate located opposite to the base plate the battery holding unit preferably has an essentially identical arrangement of contacting rail section arranged in a star shaped relative to one another and the turntable.

By means of the arrangement of the contacting rail sections with the manoeuvring means it is possible for electrochemical cells to be manoeuvred within the battery holding unit. Alternatively the manoeuvring means can also comprise a disk that can be moved longitudinally. The contacting rail sections can be configured in a wide variety of ways and in cross-section, in particular, can be configured in accordance with the possible configurations of the contacting rails and the contact surfaces already cited above.

The invention furthermore concerns a method for introducing the electrochemical cells into a battery holding unit, with the following steps: Deposition of the electrochemical cell on a support surface of the battery holding unit, bringing of a current collector of the electrochemical cell into contact with a contact surface of a contacting rail of the battery holding unit, movement of the electrochemical cell along a direction of insertion up to a defined rest location, wherein the current collector is preferably in continuous contact with the contacting rail during the movement. Negligible interrupts, in particular conditioned by interrupts of the contacting rail, are thereby included in the term “continuous contact”.

Two or a plurality of electrochemical cells are preferably firstly arranged on a support surface and are then moved together with the support surface relative to the contacting rail, in particular along a longitudinal axis of the contacting rail. The advantages and opportunities for further development cited with reference to the device ensue.

Further advantages, features and application possibilities of the present invention ensue from the following description in conjunction with the figures. Here:

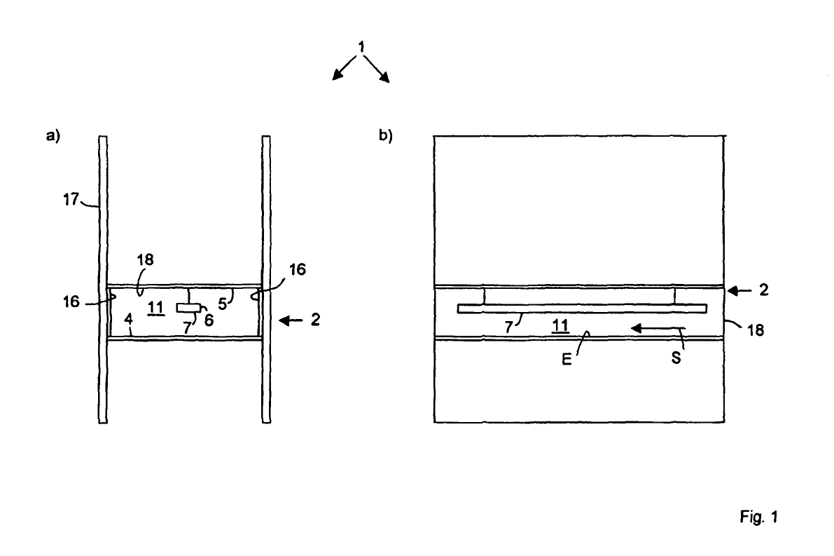

FIG. 1: shows an inventive battery station,
a) in a frontal view
b) in a side view

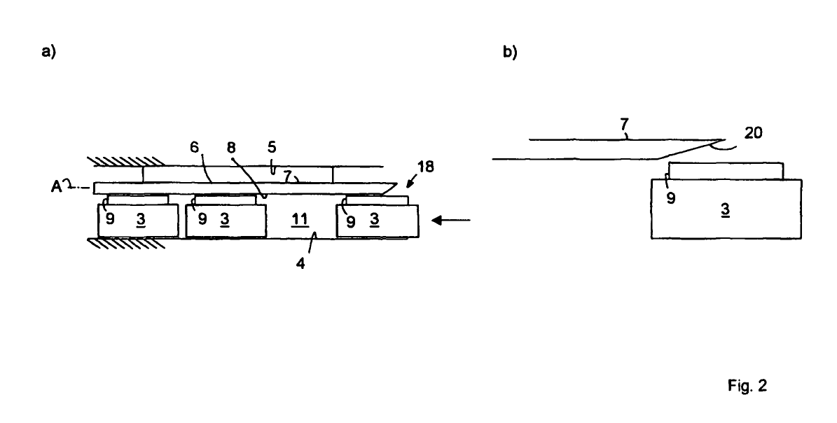

FIG. 2: shows detailed features of the battery station in FIG. 1a),
a) in detail in a side view,
b) in an enlarged representation in a side view,

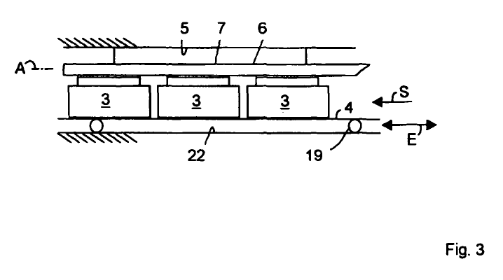

FIG. 3: shows the arrangement in FIG. 2 in an alternative form of embodiment in a side view.

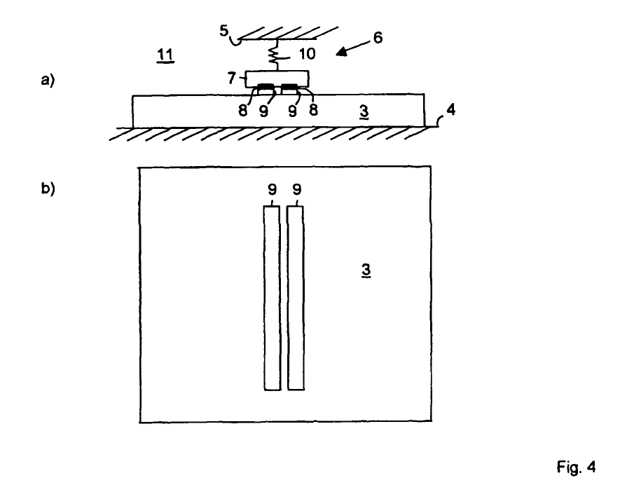

FIG. 4: shows an electrochemical cell in a first form of embodiment
a) within a battery holding unit in a frontal view,
b) in a plan view;

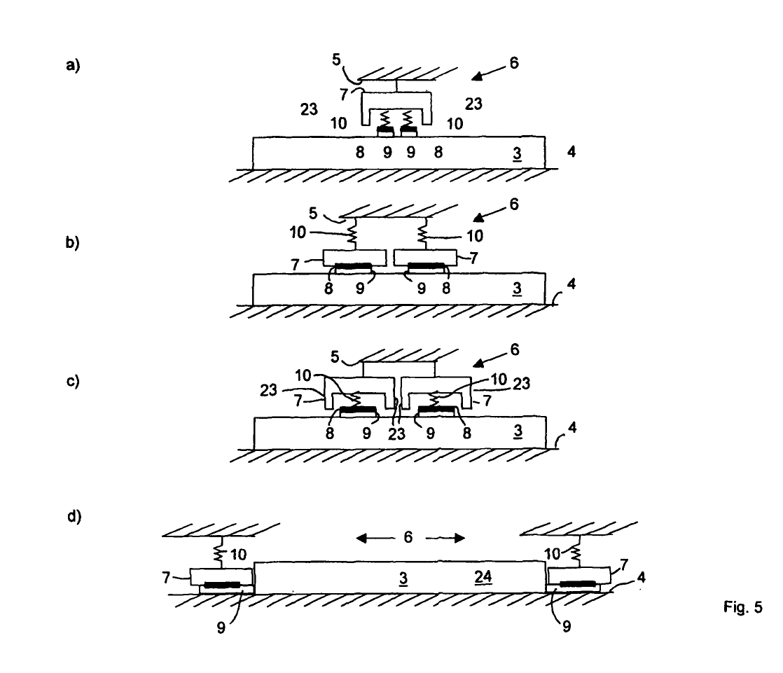

FIG. 5: shows an electrochemical cell within a battery holding unit
a) in a second form of embodiment in a frontal view,
b) in a third form of embodiment in a frontal view,
c) in a fourth form of embodiment in a frontal view,
d) in a fifth form of embodiment in a frontal view,

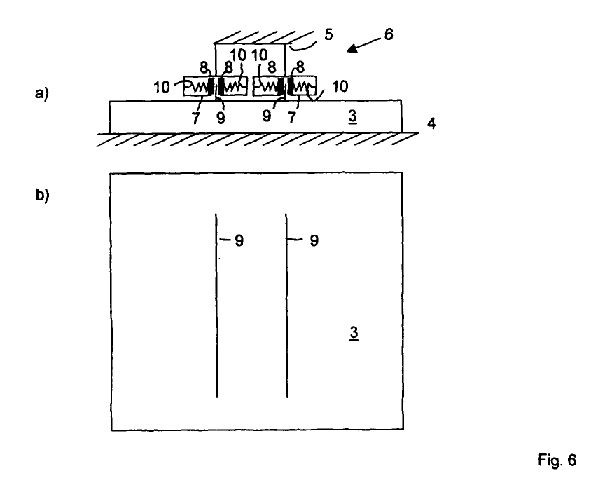

FIG. 6: shows an electrochemical cell in a sixth form of embodiment
a) within a battery holding unit in a frontal view,
b) in a plan view;

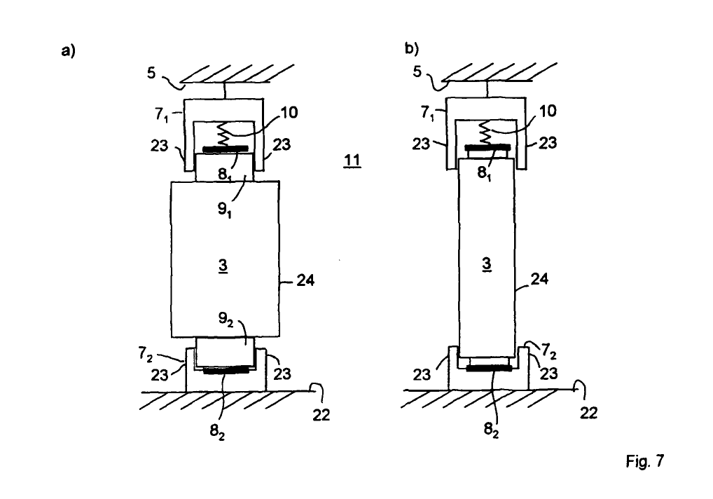

FIG. 7: shows an electrochemical cell within a battery holding unit
a) in a seventh form of embodiment in a frontal view,
b) in an eighth form of embodiment in a frontal view,

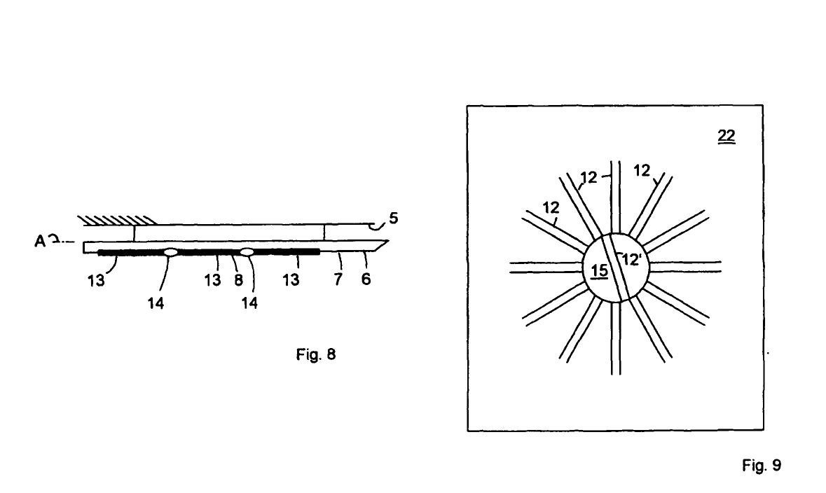

FIG. 8: shows a plurality of contact surface sections comprising the contact surface, insulated from one another, in a side view;

FIG. 9: shows a base plate with contacting rail sections arranged thereon, aligned in a star shape relative to one another, and a turntable, in a plan view;

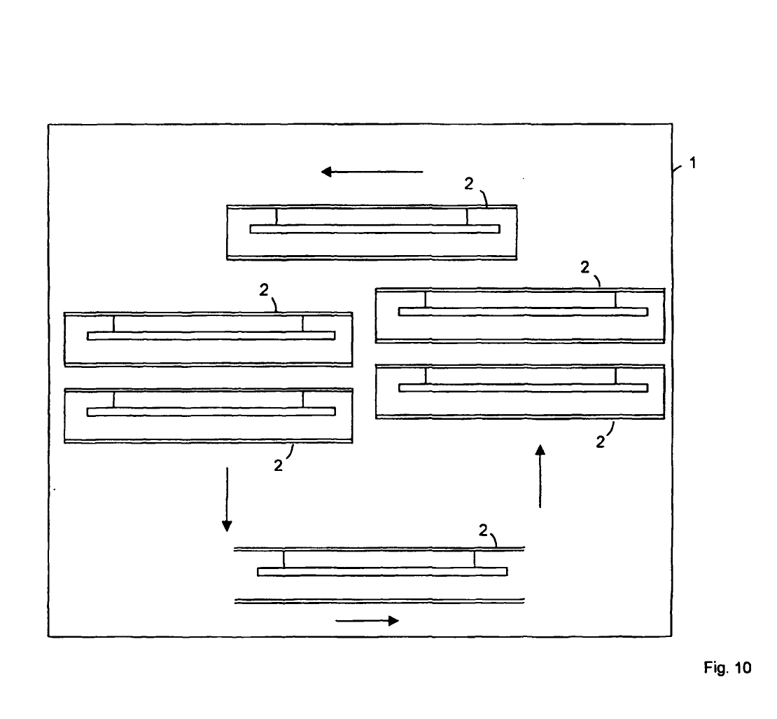

FIG. 10: shows an inventive battery station comprising a plurality of battery holding units, arranged such that they can move relative to one another, in a side view.

FIG. 1 shows an inventive battery station 1. The battery station 1 possesses a plurality of battery holding units 2 of which only one battery holding unit 2 is shown. Further battery holding units 2 are arranged vertically above and below the battery holding unit 2 shown. The battery holding unit 2 shown serves to accommodate at least one electrochemical cell 3, which is not represented in FIG. 1.

The battery holding unit 2 has a support surface 4, which is arranged vertically below, and a top surface 5, which is arranged vertically above. Sidewalls 16 connect the support surface 4 and the top surface 5 with one another in a fixed position. The battery holding unit 2 shown and also further battery holding units, not shown, are accommodated in a housing 17 of the battery station 1, which is not described in any further detail. The support surface 4 is arranged in a plane E. The top surface 5 is arranged parallel to, but vertically spaced apart from, the plane E.

A contacting unit 6 is accommodated suspended from the top surface 5 and points from the top surface 5 in the direction towards the support surface 4. The contacting unit 6 has a contacting rail 7, which has an elongated extent, and extends over almost the whole length of the support surface 4 and/or the top surface 5. The battery holding unit 2 has an insertion opening 18, through which the electrochemical cells, not represented, can be inserted into an holding space 11, which is formed between the support surface 4 and the top surface 5. The electrochemical cells are thereby introduced into the holding space 11 in the direction of insertion S.

FIG. 2a) shows the procedure for introducing the electrochemical cells 3 into the holding space 11. The electrochemical cells are guided through the insertion opening 18 into the holding space 11. Here the electrochemical cells 3 slide on the support surface 4 along a longitudinal axis A of the contacting rail 7. The electrochemical cells 3 can make contact with the contacting unit 6 at different axial positions. Here the contacting rail 7 extends over an axial path that corresponds to a multiple of the extent of the electrochemical cells 3 in this direction, namely along the longitudinal axis A. In FIG. 2b) it can be discerned that the contacting rail 7 has a chamfer 20 at the end facing towards the insertion opening 18, which serves to provide improved guidance of the current collector 9 when guiding the current collector onto the contacting unit 6.

FIG. 3 shows an alternative arrangement of the battery station 1. In contrast to the battery station in FIG. 2 the support surface 4 is not held in a fixed position within the battery station. Instead the contacting unit 6 can be moved in the plane E along the longitudinal axis A of the contacting rail 7. For this purpose a mounting is provided with a plurality of schematically represented rollers 19, by means of which the support surface 4 is held, such that it can be moved on a bottom surface 22, the latter being held in a fixed position within the battery holding unit 2. This arrangement offers the advantage that all the electrochemical cells to be arranged on a support surface 4 can firstly be seated on the support surface 4. In a further step of the method the movement of all the electrochemical cells 3 together then takes place along the contacting rail 7 up to defined locations, in which the electrochemical cells 3 remain within the battery holding unit 2 for operational purposes. In the configurations shown in FIGS. 2 and 3, the direction of insertion S, along which the electrochemical cells are moved into the holding space 11, is aligned parallel to the longitudinal axis A.

In FIG. 4b) an electrochemical cell 3 is shown in a plan view. It can be discerned that two current collectors 9 of the electrochemical cells 3 of elongated design run parallel to one another; however, these can also be designed to be significantly shorter. In FIG. 4a) the electrochemical cell 3 is shown within the holding space 11 in a frontal view. The electrochemical cell 3 is seated on the support surface 4. The contacting unit 6 with the contacting rail 7 can also be discerned. Spring means 10 impose a force by the top surface 5 on the contacting rail 7 in the direction of the support surface 4. Two contact surfaces 8 are arranged on a lower face of the contacting rail 7; these extend in the longitudinal direction of the contacting rail 7. The contact surfaces 8 are in direct contact with the current collectors 9 such that current can be transferred. The contacting rail 7 has an essentially rectangular cross-section. The electrochemical cell 3 is held in a force fit within the battery holding unit 1.

Alternative forms of embodiment of the contacting unit 6 are represented in FIG. 5. To a large extent the contacting unit represented in FIG. 5a) corresponds to the contacting unit 6 in FIG. 4. In a deviation from the latter the contacting rail 7 is held in a fixed position relative to the top surface 5. The contacting rail 7 has an essentially U-shaped cross-section, wherein two spring means 10 are provided within the U-shaped cross-section, by means of which a force can be applied to the two contact surfaces 8 in the direction of the support surface 4. Sidewalls 23 of the contacting rails 7 can thereby protect the spring means 10 from external influences. The sidewalls 23 can also project further in the direction of the support surface 4, so that the sidewalls 23 also project beyond the contact surfaces 8 and can thereby guide the current conductors laterally.

To a large extent the contacting unit represented in FIG. 5b) corresponds to the contacting unit 6 shown in FIG. 4. In a deviation from the latter the contacting unit 6 has two separate contacting rails 7 each of which carries a contact surface 8.

To a large extent the contacting unit 6 represented in FIG. 5c) corresponds to the contacting unit 6 shown in FIG. 5a). In a deviation from the latter two separate contacting rails 7 are provided, on each of which a contact surface 8 is fitted.

To a large extent the contacting unit represented in FIG. 5d) corresponds to the contacting unit 6 shown in FIG. 5b). In a deviation from the device of FIG. 5b) the current collectors 9 of the electrochemical cells 3 are arranged laterally outboard on opposite sides of the electrochemical cell 3. In this respect the two contacting rails 7 of the contacting unit 6 are also arranged at a greater distance apart from one another. The current collectors 9 are in contact with the support surfaces 4. A compression force that is applied by the spring means 10 onto the current collectors 9 is directly transferred from the current collectors 9 onto the support surface 4. In this manner the base body 24 of the electrochemical cell 3, which comprises the essential galvanic elements of the electrochemical cell 3, is to a large extent not subjected to the forces of the spring means 10.

FIG. 6 shows an alternative configuration of the contacting unit 6, which to a large extent corresponds to the configuration in FIG. 5c). In what follows only the differences will be dealt with. The contacting unit 6 shown in FIG. 6 is suitable for electrochemical cells 3 that have current collectors 9 that project transversely from a casing of the electrochemical cell 3. Contact surfaces 8 of the contacting unit 6 make contact with the current collectors 9 along surfaces that are aligned at right-angles to the support surface 4. Thus at an axial location 6 of the contacting rail two contact surfaces 8 are provided per contacting rail 7, between which a current collector 9 is held in each case. The current collector 9 can be held by the contact surfaces 8 in a force fit. Here the contacting rails 7 each have a cavity, in which two spring means 10 are arranged in each case; these force the two contact surfaces 8 together. The spring means 10 can generate a high normal force onto the contact surfaces and the current collectors 9, such that the electrochemical cell 3 can be held sufficiently securely against inadvertent movement from the defined location by this means. The contacting rails 7 are held in a fixed position relative to the top surface 5.

The arrangements shown in FIG. 7 are particularly suitable for round cells and to a large extent correspond to the arrangement in accordance with FIG. 5c). In what follows only the differences will be dealt with. In FIG. 7a) a round cell 3 can be discerned, which is held in the holding space 11 by means of two contacting rails 7₁, 7₂. The upper contacting rail 7₁ essentially corresponds to the contacting rail 7 in FIG. 5c). The sidewalls 23 of the upper contacting rail 7₁ project downwards to the extent that the upper current collector 9₁ is guided laterally by the sidewalls 23. Sidewalls 23 of the lower contacting rail 7₂ project upwards to the extent that the lower current collector 9₂ is guided by the sidewall 23. The support surface on which the round cell 3 is seated is formed by the lower contact surface 8₂. The lower contact surface 8₂ is supported on the bottom surface 22 of the battery holding unit 2.

FIG. 7b) shows an alternative configuration of the battery holding unit of FIG. 7a), wherein only the differences will be dealt with. Here the sidewalls 23 of the upper and lower contacting rails project in the direction of the other contacting rail 7₁, 7₂ in each case, to the extent that the sidewalls 23 can support a base body 24 of the electrochemical cell laterally.

For both devices shown in FIG. 7 it is also possible for the spring means 10 to be arranged at another location. Thus in particular the contact surfaces 8 of the upper contacting units 6 can also be connected rigidly with the upper contacting rail 7₁. Here the spring means 10 can be arranged between the contacting rail 7 and the top surface 5. Furthermore the spring means can also be fitted to the lower contacting rail 7₂.

FIG. 8 shows a further configuration of the contacting unit 6, which in particular is also applicable to the various configurations of the previous figures. A contact surface 8 that is assigned to a contacting rail 7 has a plurality of contact surface sections 13 arranged axially one behind another, which are arranged along a common longitudinal axis A. Insulating sections 14 are provided between individual contact surface sections 13, such that individual contact surface sections need not be in electrical contact, even if they are arranged adjacent to one another. By this means flexible circuit connections between different contact surface sections become possible, as a result of which in turn flexible circuit connections between the electrochemical cells that are in contact with the contact surface sections become possible.

FIG. 9 shows details of a further development of an inventive battery holding unit. Here a plurality of contacting rail sections 12 arranged in a star shape relative to one another can be discerned in a plan view onto a bottom surface 22. A turntable 15 is arranged at the centre of the contacting rail sections 12 arranged in a star-shape; this has a separate contacting rail section 12′, which runs through a centre point of the circular turntable 15. A corresponding mirror image arrangement is provided on the top surface 5. The contacting rail sections 12, when viewed in cross-section, can in particular be configured as shown in FIGS. 7a) and b). An electrochemical cell can be conveyed via a contact surface section 13 to or from the turntable 15. The turntable 15 thereby enables the transposition of an electrochemical cell 3 from one contacting rail section 12 to another contacting rail section 12, in particular to one arranged at an angle. In overall terms manoeuvring of electrochemical cells 3 within the battery holding unit 2 is enabled by means of this arrangement. This is in particular of advantage in automated battery stations, if individual electrochemical cells 3 must be replaced.

FIG. 10 shows a battery station 1 in a further form of embodiment. The battery station 1 comprises a plurality of battery holding units 2 of the type cited above. As an alternative to the battery station 1 that is shown in FIG. 1, the individual battery holding units 2 are held such that they can move within the battery station 1. In particular the battery holding units 2 can be moved in a rotating manner similar to that of a paternoster lift. The configurations shown in FIGS. 2 to 9 can also find application in this battery station.

### REFERENCE SYMBOL LIST

1 Battery station
2 Battery holding unit
3 Electrochemical cell
4 Support surface
5 Top surface
6 Contacting unit
7 Contacting rail
8 Contact surface
9 Current collector
10 Spring means
11 Holding space
12 Contacting rail section
13 Contact surface section
14 Insulating section
15 Turntable
16 Sidewalls
17 Housing
18 Insertion opening
19 Rollers
20 Chamfer
22 Bottom surface
23 Sidewalls
24 Base body
A Longitudinal axis
E Plane
S Direction of insertion

1. A battery holding unit to accommodate at least one electrochemical cell, comprising:
a support surface to deposit an electrochemical cell; and
a contacting unit including a contact surface to be brought into contact with a current collector of the electrochemical cell, the contacting unit (6) includes at least one contacting rail, on which the contact surface is arranged
wherein the support surface is held within the battery holding unit such that it can be moved relative to a longitudinal axis of the contacting rail.

2. The battery holding unit in accordance with claim 1, further comprising springs to impose a force on the contact surface.

3. The battery holding unit in accordance with claim 1, wherein the contacting rail has a greater extent along a longitudinal axis of the contacting rail than an electrochemical cell that is to be inserted.

4. The battery holding unit in accordance with claim 1, wherein the contacting rail has an essentially linear profile or stretch or run.

5. The battery holding unit in accordance with claim 1, wherein the contacting rail is arranged spaced apart from the support surface.

6. The battery holding unit in accordance with claim 1, wherein the contacting rail forms the support surface.

7. The battery holding unit in accordance with claim 1, wherein the support surface is arranged in a plane, and the contacting rail is aligned parallel to this plane.

8. The battery holding unit in accordance with claim 1, wherein the contacting rail has means for the lateral guidance of an electrochemical cell.

9. The battery holding unit in accordance with claim 1, wherein the contact surface includes a plurality of contact surface sections, and individual contact surface sections (13) are insulated from one another.

10. The battery holding unit in accordance with claim 1 wherein the support surface is held within the battery holding unit such that it can be moved.

11. The battery holding unit in accordance with claim 1, wherein the battery holding unit has manoeuvring means.

12. A battery station, or a forming plant, or a battery charging unit, with at least one battery holding unit in accordance with claim 1.

13. A method for the introduction of electrochemical cells into a battery holding unit, comprising:
depositing the electrochemical cell on a support surface of the battery holding unit;
bringing a current collector of the electrochemical cell into contact with a contact surface of a contacting rail of the battery holding unit; and
moving the electrochemical cell along a direction of insertion up to a defined rest location, wherein the current collector is in continuous contact with the contacting rail during the movement.

14. The method in accordance with claim 13, wherein at least two electrochemical cells are firstly arranged on a support surface and are then moved together with the support surface relative to the contacting rail.

15. The battery holding unit in accordance with claim 10, wherein the support surface is held such that it can be moved relative to a longitudinal axis of the contacting rail.

16. The method in accordance with claim 14 wherein the at least two electrochemical cells are moved together along a longitudinal axis of the contacting rail.
